(19) United States
(12) Patent Application Publication
(10) Pub. No.: US 2011/0291588 A1
(43) Pub. Date: Dec. 1, 2011

(54) LIGHT FIXTURE WITH AN ARRAY OF SELF-CONTAINED TILES

(76) Inventor: Madhavi V. TAGARE, San Jose, CA (US)

(21) Appl. No.: 12/786,848

(22) Filed: May 25, 2010

(51) Int. Cl. H05B 37/02; H05B 41/36; F21S 4/00

(52) U.S. Cl. 315/294; 362/249.02; 362/249.06; 315/291

(57) ABSTRACT

The present invention describes light fixtures comprising an array of self-contained LED tiles for illuminating light from a surface area of a respective light fixture. Each of the array of LED tiles is a self-contained lamp that contains its respective own AC or DC input power supply and LED driver, its respective heat dissipation element, and its respective light collation element. The array of tiles makes the total illumination from the array to be sufficiently bright, even though any given LED tile might only have a modest amount of light output. Embodiments of the LED tiles for use with various lamp fixtures include, but not limited to, a hexagon-shaped LED tile, a square-shaped LED tile, an equilateral triangle-shaped LED tile, and a rectangle-shaped LED tile with an aspect ratio, for example, of 3:1. The different types of LED tiles are suitable for use to cover various types of surfaces of lamp fixtures.

### TECHNICAL FIELD

The present invention relates generally to lighting systems, and more particularly to lighting constructed with light emitting diodes (LEDs).

### BACKGROUND

Lamp fixtures traditionally have been designed for incandescent lamps. Incandescent lamps produce light by heating up a filament in which a bulb occupies a relatively small volume relative to the light fixture. The light fixture functions to collate and distribute light in a manner that is suitable for an entire room, which requires a large area for illumination, and thus involves surfaces that have a relatively large area.

In the illumination industry, consumers have a wide interest for various types of illuminations and aesthetic preferences. This is accommodated by a two-layer industry structure of a relatively large number of fixture manufacturers who design different types of fixtures around a few basic lamp types. The lamps are made by a few manufacturers with sophisticated technology, while the numerous fixture manufacturers utilize relatively simpler materials and manufacturing techniques to provide the fixtures. Typically, such fixtures are large in size compared to a bulb, and employ reflectors or diffusers of light to provide illumination over a large area suitable for use by humans.

Due in part that the power consumed by an incandescent lamp is emitted as radiation in a visible spectrum, the efficiency of such lamps, measured in lumens/watt, is rather low. For this reason, there is a growing trend in seeking a more efficient design to replace the incandescent lamps. One technology solution that has gained popularity relates to compact fluorescent lights (CFLs). These CFLs utilize a different mechanism of generating plasma to stimulate a phosphorescent layer. The CFL manufacturers have found it easy to adapt them to fit conventional bulb sockets.

Another illumination technology which delivers even greater efficiencies is light emitting diodes (LEDs), which are semiconductor devices made by growing particular layers on semiconductor wafers and subsequently cutting them into little dice. Because of the ubiquity of conventional lamp fixtures, as well as the success of both CFLs and incandescent bulbs in such fixtures, the current emphasis of the LED industry is to provide a bulb which is a screw-in replacement for the conventional light fixture.

This effort of the LED lighting industry to create LED bulbs that can replace the incandescent bulbs has led to two basic problems that the LED lighting industry is confronted with. The first concern relates to the difficulty of obtaining sufficient light out of one or few LED chips that are concentrated in a small volume. The second concern relates to the problem of extracting heat from the LED chips, as the reliability of these LEDs is sensitive to their temperature. Several passive, quasi-passive, and active airflow solutions have been employed to address the thermal issues of LED bulbs.

Besides the LED chips and the heat dissipation apparatus, an LED bulb also contains two other modules. A first module contains optics for distributing light widely from a small point source and a second module contains electronics for power conversion from the AC that a lamp fixture is expected to be plugged into, as well as circuitry for driving the LED chips with a constant current source. The optics themselves typically do not present any significant problems. The electronics, however, can raise some potential issues. LEDs generally are designed as DC powered devices, which require some sort of AC to DC conversion that involves bulky components like transformers and electrolytic capacitors. While LEDs themselves, with a suitable thermal management design, can be made to achieve the high reliability that is typically associated with semiconductors, the presence of electrolytic capacitors tends to limit the overall reliability of the LED bulb. In addition, due to the necessity to generate a large amount of light, relative to what is possible with one LED chip, the electronics in a bulb often drives a string of LEDs. Thus, multiple LEDs are controlled by a single driver, which is not able to power individual LED optimally.

FIG. 1 is a conventional incandescent bulb inside a light fixture 12. The light fixture 12 surrounding a bulb 14 spreads the light emitted from the incandescent bulb. Since the light is generated by the hot filament inside the bulb, the bulb 14 has the approximate shape as shown. One shortcoming of the incandescent bulbs is that they produce lower light efficiency relative to LED lighting.

Accordingly, for the foregoing reasons stated above, it is desirable to have a light apparatus that provides sufficient light from an array of LED devices while reducing the amount of heat. It is also desirable to provide a retrofit solution which leverages from existing lamp fixture manufacturers and the light bulb industry. It is further desirable to design light apparatuses with the capability to control an individual LED in the array of LED devices for adjustment of electrical current in each LED, correcting light intensity and temperature, as well as extracting maximum illumination from the array of LED devices.

### SUMMARY OF THE INVENTION

The present invention describes light fixtures comprising an array of self-contained LED tiles for generating light from a surface area of a respective light fixture. Each of the array of LED tiles is a self-contained lamp that contains its respective own AC or DC input power supply and LED driver, its respective heat dissipation element, and its respective light collation element. The array of tiles makes the total illumination from the array to be sufficiently bright, even though any given LED tile might only have a modest amount of light output. The surface area of the light fixture is broadly construed to include a plane surface, an open face, or a surface-extending area that defines an inner hollow area.

Embodiments of the LED tiles for use with various lamp fixtures include, but are not limited to, a hexagon-shaped LED tile, a square-shaped LED tile, an equilateral triangle-shaped LED tile, and a rectangle-shaped LED tile with a specified aspect ratio. The different types of LED tiles are suitable for use to cover various types of surfaces of lamp fixtures.

The heat dissipation is also enhanced by means of a relatively large surface area of a light fixture. With the arrangement of multiple tiles on the fixture area, the heat generated from the LEDs is spread across the area. The heat sink in each tile further enhances heat dissipation, and may also act as a secondary collator of light.

Advantageously, the present invention provides a retrofit solution to existing lamp and bulb industries by providing a lamp adaptor plate, which on a first side having a multiplicity of sockets for plugging in the respective LED tile and on a second side having a conventional bulb socket to screw into an existing light bulb mounting. This feature enables end customers to re-use their existing lamps and lamp bases.

Broadly stated, a light apparatus, comprises a surface area for illumination; a plate assembly spaced apart from the surface area having a plurality of sockets; and a plurality of individually replaceable LED tiles, each LED tile coupled to a corresponding socket, the plurality of individually replaceable LED tiles extending from the socket to form a lighting surface for projecting light.

The structures and methods of the present invention are disclosed in the detailed description below. This summary does not purport to define the invention. The invention is defined by the claims. These and other embodiments, features, aspects, and advantages of the invention will become better understood with regard to the following description, appended claims and accompanying drawings.

### BRIEF DESCRIPTION OF THE DRAWINGS

The invention will be described with respect to specific embodiments thereof, and reference will be made to the drawings, in which:

FIG. 1 is a prior art diagram of a conventional incandescent bulb inside a fixture to spread the light out over a broad area.

FIG. 2 illustrates a light fixture using a surface area to produce light in accordance with the present invention.

FIG. 3 illustrates a cross sectional view of an exemplary embodiment of a self-contained LED module tile in accordance with the present invention.

FIGS. 4A-D are pictorial diagrams illustrating top views of exemplary shapes of the self-contained LED tile in accordance with the present invention.

FIGS. 5A-C are exemplary light lamps that serve different utilization purposes designed with various shapes of the self-contained LED module tile in accordance with the present invention.

FIG. 6 illustrates two self-contained LED module tiles that are plugged, respectively, into two sockets of an adaptor plate in accordance with the present invention.

FIG. 7 shows an incandescent lamp in a shade replaced by the adaptor plate with two LED tiles in accordance with the present invention.

FIG. 8A illustrates a circular adaptor plate containing multiple sockets for plugging in multiple self-contained LED module tiles in accordance with the present invention; FIG. 8B illustrates a lamp fixture for employing hexagonal-shaped self-contained LED tiles in accordance with the present invention.

FIGS. 9A-B illustrate a second embodiment in employing square-shaped self-contained LED module tiles in a rectangular lamp fixture in accordance with the present invention.

FIGS. 10A-B illustrate a third embodiment in employing a rectangular-shaped self-contained LED module in a cylindrical lamp fixture in accordance with the present invention.

FIGS. 11A-B illustrate a trapezoidal lampshade and a corresponding plate adaptor, respectively, constructed with an array of self-contained triangular LED module tiles in accordance with the present invention.

FIG. 12A illustrates an alternate embodiment of the hexagonal tile with the LED mounted on the hexagonal LED module tile in accordance with the present invention; FIG. 12B illustrates the cross-section of the hexagonal tile in accordance with the present invention.

FIG. 13 illustrates an alternative embodiment of an LED module tile that contains the self-contained LED module tile and the heat sink, without an AC-DC supply in accordance with the present invention.

FIG. 14 illustrates a simplified flowchart showing the process in the design of a light fixture using the self-contained LED module tiles in accordance with the present invention.

### DETAILED DESCRIPTION

A description of structural embodiments and methods of the present invention is provided with reference to FIGS. 2-14. It is to be understood that there is no intention to limit the invention to the specifically disclosed embodiments but that the invention may be practiced using other features, elements, methods and embodiments. Like elements in various embodiments are commonly referred to with like reference numerals.

FIG. 2 illustrates a light fixture (including a fixed light apparatus, or a portable/free-standing light apparatuses) 16 using a surface area 20 for illumination. The light fixture 16 produces light as generated from a light source 18 and defines the shape and illumination area 20. The light source 18 is distributed over the surface area 20 of the light fixture 16. The light source 18 (also referred to as “LED tile”, “LED module”, or “LED module tile”) comprises one or more self-contained LED module tiles (also referred to as LED tiles). Each LED module tile represents a small light device, which has its own AC or DC input power supply and LED driver, its own heat dissipation element, and its own light collation element. By arranging the LED tiles in a particular configuration, light is still presented for use in the same way as before.

For additional information on the circuit and operation of the AC or DC input power supply, see U.S. patent application Ser. No. 12/715,192 entitled “AC or DC Power Supply Employing Sampling Power Circuit”, filed on 1 Mar. 2010, by Madhavi V. Tagare, which is incorporated by reference as if fully set forth herein.

The light fixture 16 with the light source 18 comprises one or more LED tiles with the surface area 20 that produces sufficient light. The plurality of LED tiles, collectively, make the total illumination from the array to be sufficiently bright. The surface area 20 in the light fixture 16, with an array of LED tiles, is able to dissipate the heat efficiently, which is attributed to the heat dissipated via the heat dissipation element of each LED tile in the array covering the large surface area 20.

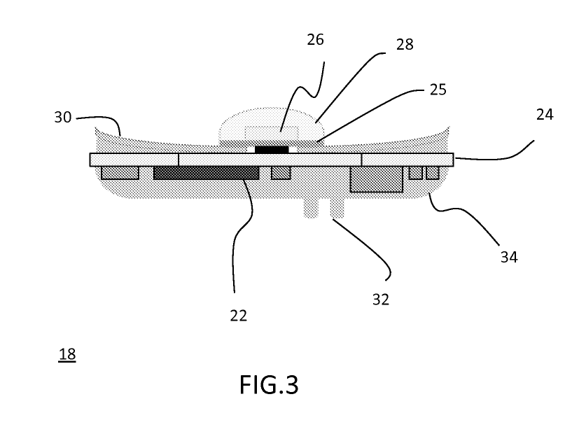

FIG. 3 illustrates an exemplary embodiment of the self-contained LED tile 18. In one embodiment, all components of the AC or DC input converter and LED driver 22 (AC/DC converter, plus an LED driver) are mounted on a first side of a printed circuit board 24. An LED 26 is mounted on a second side of the printed circuit board 24. The LED 26 is placed inside an optics 28 for bringing out maximum amount of light. A heat sink 30 is mounted on the same side of the printed circuit board 24 as the LED 26 and is connected to a heat sink terminal 25 of the LED 26. The heat sink (or reflector) 30 is shaped so that the heat sink 30 acts as a secondary collector of the light emitted from the LED 26. A connector 32 is used to fit an LED module tile into a base of a light fixture. An electrically insulating epoxy 34 is used to cover the LED module tile 18.

If the AC or DC input converter 22 can be designed without the use of any bulky components, including electrolytic capacitors, the thickness of the LED module tile 16 can be designed with a relatively small dimension. In some embodiments, the LED module tile 16 is approximately equal to the height of standard electronics components (about 2 to 3 mm), plus thickness of the printed circuit board 24 (less than 1 mm), plus the height of the LED (about 2 mm) or the height of the heat sink 30, if the heat sink 30 curves up to collimate the light. As a result, the dimension of LED module tiles can be thin (˜7 mm), light in weight, and easily mountable into a base of a light fixture. In this exemplary embodiment, the width to height aspect ratio is 3:1.

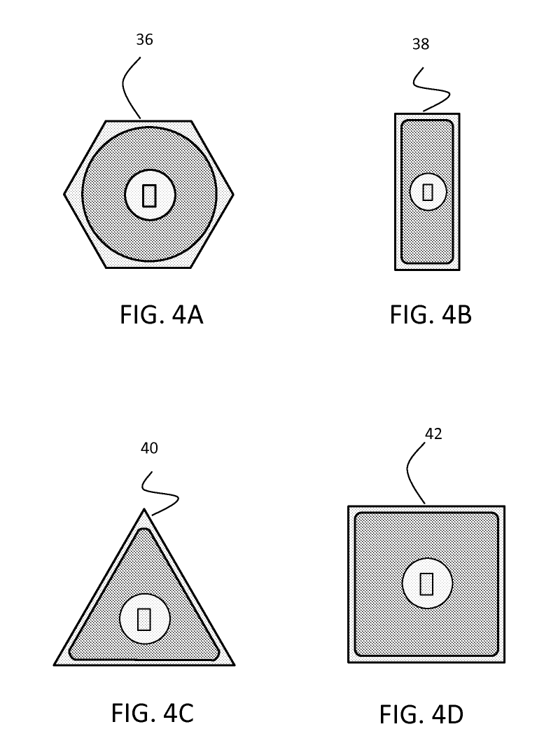

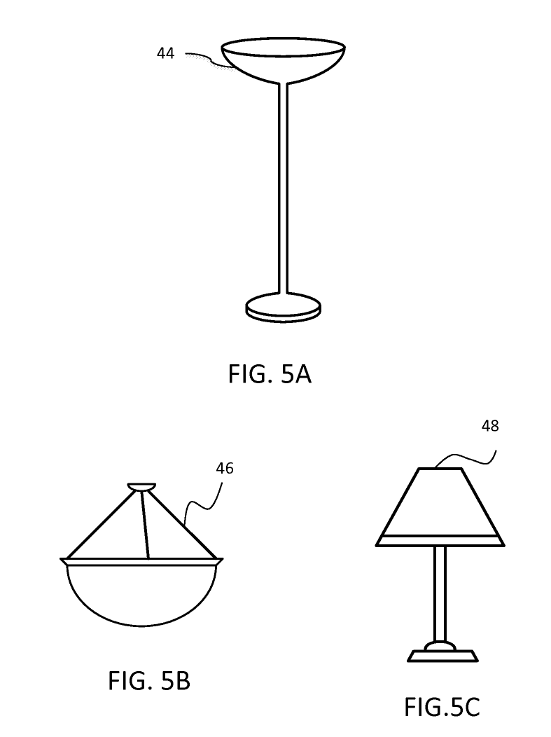

FIGS. 4A-4D are pictorial diagrams illustrating exemplary shapes of the self-contained LED module tile 18. The shapes as shown in FIGS. 4A-4C are suitable for the various lamps described with respect to FIGS. 5A-5C. In a first exemplary shape, a hexagonal tile 36 can be used while covering circular or oval lamp shapes. In a second exemplary shape, a rectangular tile 38 can be used for longer geometries of lamp fixtures. In a third exemplary shape, a triangular tile 40 can be used to create trapezoidal-shaped lamp fixtures. In a fourth exemplary shape, a square tile 42 provides another building block to build suitable fixtures with square sides. Other shapes of tiles such as circular, star-shaped or trapezoidal are also possible to cover some other surfaces or to make the lamp fixture aesthetically more appealing. To accommodate both big and small lamp form factors, the LED module tiles can be manufactured in various dimensions with a selected shape for use in various types of light lamps.

FIGS. 5A-C are exemplary light lamps that serve different utilization purposes designed with various shapes of the self-contained LED module tile 18. Depending on the preferences, a standing lamp 44 produces light that projects in an upward direction. A down light fixture 46 illuminates light in a downward direction. A table lamp 48 can be used for reading or illuminating smaller area in a room.

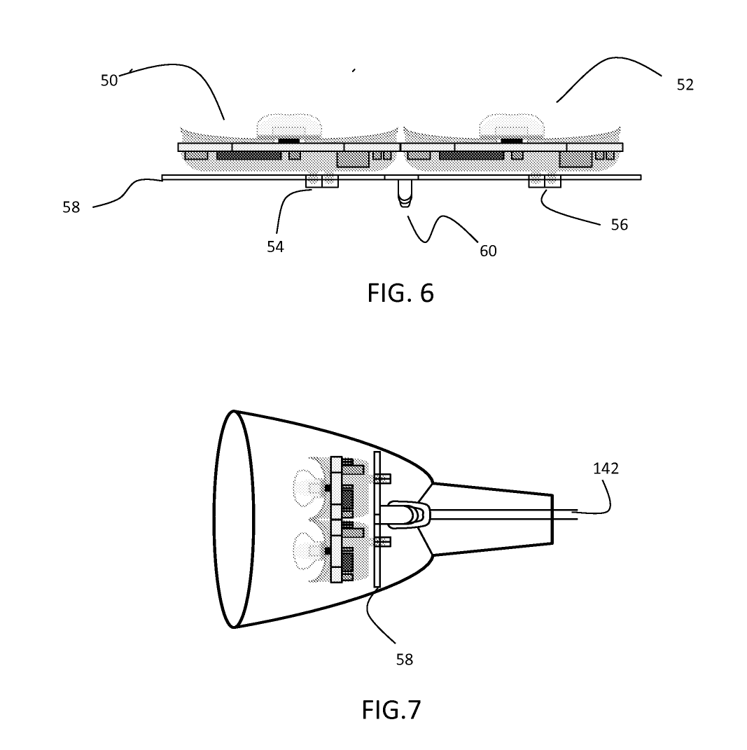

FIG. 6 illustrates two self-contained LED module tiles 50, 52 that are plugged, respectively, into sockets 54, 56 of an adaptor plate 58. The adaptor plate 58 is designed in the shape suitable for the lamp fixture under consideration. The adaptor plate 58 is shaped and contains a sufficient number of sockets necessary to cover the required lamp fixture 44, 46, or 48. The adaptor plate 58 has an extension 60 on the other side to fit into the standard AC light socket of an incandescent bulb in the lamp fixture 44, 46, or 48.

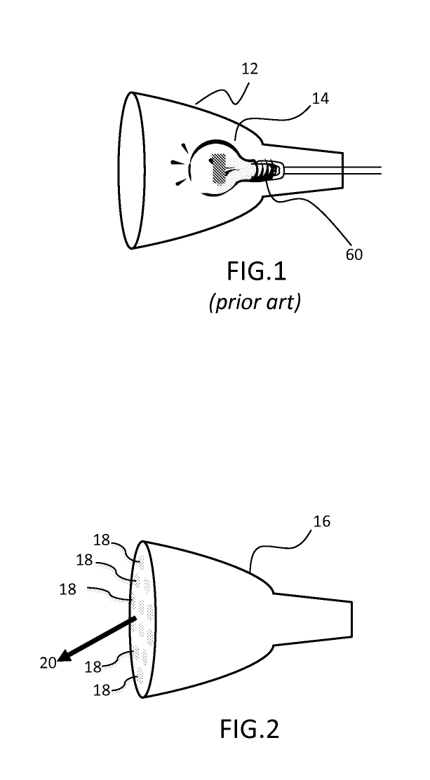

FIG. 7 shows how the lampshade 12 can be used with the self-contained LED module tiles 50, 52. The adaptor plate 58 containing two self-contained LED module tiles 50, 52 with extension 60, as shown in FIG. 7, replaces the incandescent lamp 14 as shown in FIG. 1. Wires 142 from the mains AC connect to the socket. Hence this is a very convenient retrofit design wherein the user or the lamp manufacturer doesn't need to change any existing structures.

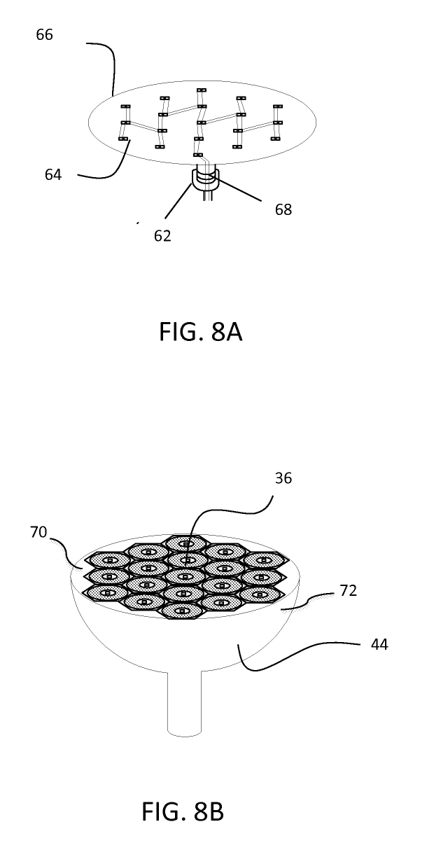

FIGS. 8A and 8B illustrate a first exemplary embodiment in employing hexagonal shaped self-contained LED module tiles inserted into sockets of a plate in the lamp fixtures 44, 46, 48 as shown in FIGS. 5A-C. FIG. 8A shows a plate 66 containing a plurality of sockets 64 disposed on a base 68 that fits into the AC socket 62 in the lamp fixture 44. FIG. 8B shows a circular lamp opening 70 covered with self-contained hexagonal LED module tiles 36 using the plate 66 to fit the self-contained hexagonal LED module tiles 36. The resulting surface area from the opening 70 is defined by the curvature 72 of the lamp fixture 44 where the light is produced from the inner area of the curvature 72 through the opening 70. One advantage of the present invention is the combination of the plate 66 and the self-contained LED module tiles, which are applicable to existing light fixtures that use a conventional incandescent bulb, as a conventional incandescent bulb is replaced by multiple of self-contained LED module tiles. The lampshade portion can extend beyond the array of self-contained LED module tiles in a modified version of the lamp.

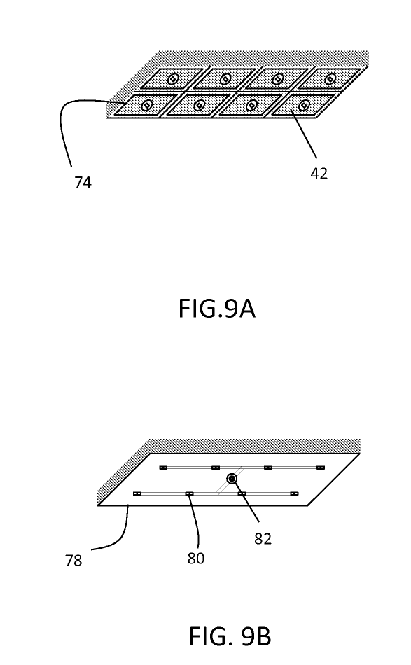

FIGS. 9A-B illustrate a second embodiment in employing square-shaped self-contained LED module tiles in a rectangular lamp fixture. A rectangular lamp assembly 74 for attachment to a ceiling can be formed out of the arrangement of the self-contained square LED module tiles 42. A rectangular plate 78 with multiple sockets 80 on one side and AC compatible connector 82 on the other side can be used in the rectangular lamp fixture 74.

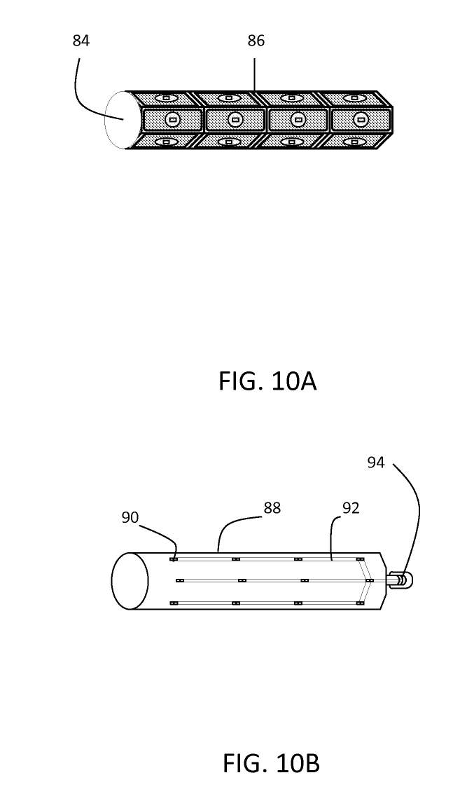

FIGS. 10A-B illustrate a third embodiment in employing a rectangular-shaped self-contained LED module in a cylindrical lamp fixture. A long cylindrical lampshade (or lamp fixture) 84 is enabled by the rectangular tiles covering the surface area 86. A cylindrical plate 88 containing multiple sockets 90 and wires 92 connecting all the sockets to the main AC connector 94 fits inside the lampshade 84.

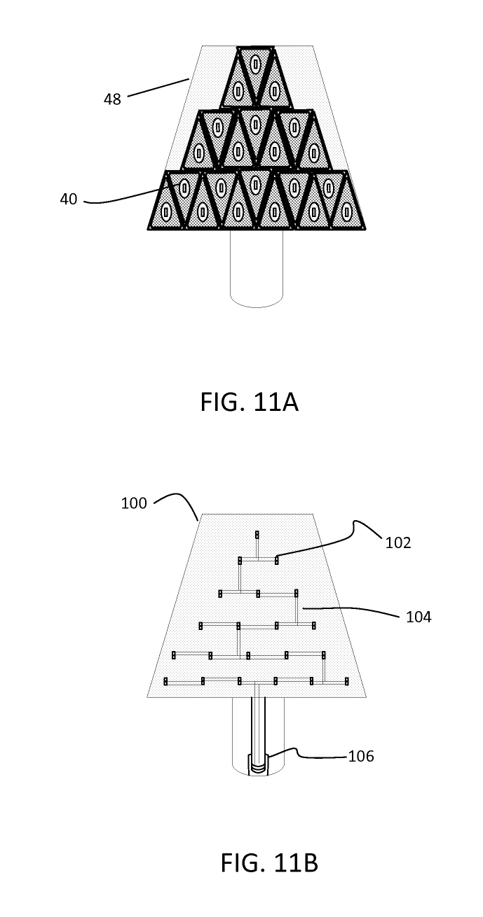

FIGS. 11A-B illustrate a trapezoidal lampshade 48 and a corresponding plate adaptor 100, respectively, constructed with an array of self-contained triangular LED module tiles 40. FIG. 11B shows the plate adaptor 100 comprising a plurality of sockets 102 connected together by the wiring 104 for fitting into a base 106. The above FIGS. 8A-11B are intended to show some examples in the different use and shape of self-contained LED module tiles. Other shapes and sizes of self-contained LED module tiles for use in a lamp fixture can be practiced within the spirits of the present invention.

The self-contained LED module tiles described above uses a metal plate that serves as a heat sink to dissipate the heat generated by the LED module tiles. Heat is dissipated by convection of air around the LED module tiles. The size of the LED module tiles, which in turn affects the size of the metal plate, fixes the amount of heat that can be dissipated in order to keep the temperature of the LED within the specification. While designing a light fixture to provide certain lumens of light output, each LED module tile delivers a fraction of the total lumens, and the fraction decided by the number of tiles. Each LED module tile dissipates the corresponding amount of heat. There could be instances where a light fixture produces a certain amount of light, which also generates the power to be dissipated in the light fixture, such that the amount of heat to be dissipated per tile is more than what is possible with a simple metal plate and air convection. These light fixtures may need specially-designed tiles capable of handling bigger power dissipation. It is expected that the power supply in the LED module tiles can be designed in a manner that allows for driving a higher current LED.

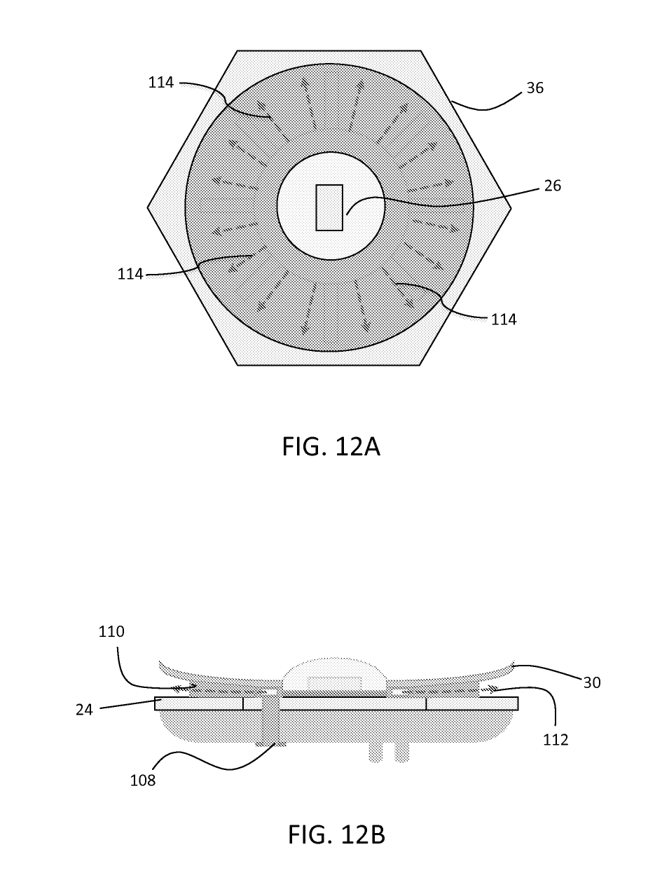

FIG. 12A illustrates a hexagonal tile 36 with the LED 26 mounted on the hexagonal tile 36. FIG. 12B illustrates the cross-section of the hexagonal tile 36. A thermal alloy 110 binds the heat sink 30 to the PCB 24. The thermal alloy 110 has small perforations 112 running outwards along the radius of the heat sink 30. An opening 108 in the PCB 24 connects the perforations 112, for example, to a vent fan in the bottom of the lamp fixture. This enables forced air flow below the heat sink 30, which enhances the heat dissipation. As shown in FIG. 12A, air flows out radially on all sides, as indicated by the arrows 114, thereby cooling the LED. A power supply in the LED module tile can be designed in a manner that allows for driving a higher electrical current LED. Unlike LED lamps that replace conventional bulbs, fans may be shared by multiple self-contained LED module tiles in a lamp fixture. Also note that a socket that is designed for these thermally-enhanced modules may house modules without such airflow needs and vice versa. This is just an exemplary enhancement to the tile to accommodate higher power dissipation. These and similar modifications can be done to have the same effect on the performance of the tiles.

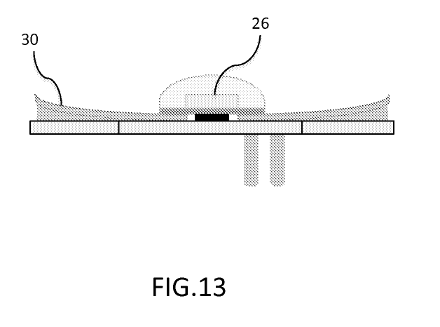

In an alternative embodiment, FIG. 13 illustrates an LED module tile that contains the LED 26 and the heat sink 30, without an AC-DC supply. In an alternative embodiment, FIG. 13 illustrates an LED module tile that contains the LED 26 and the heat sink 30, without an AC-DC supply. In this embodiment, the adaptor plate may contain one or more LED drivers. Additionally, the adaptor plate may contain one or more AC or DC input power supplies. Other embodiments of the LED tile 18 in FIG. 3 may include a plurality of LEDs 26.

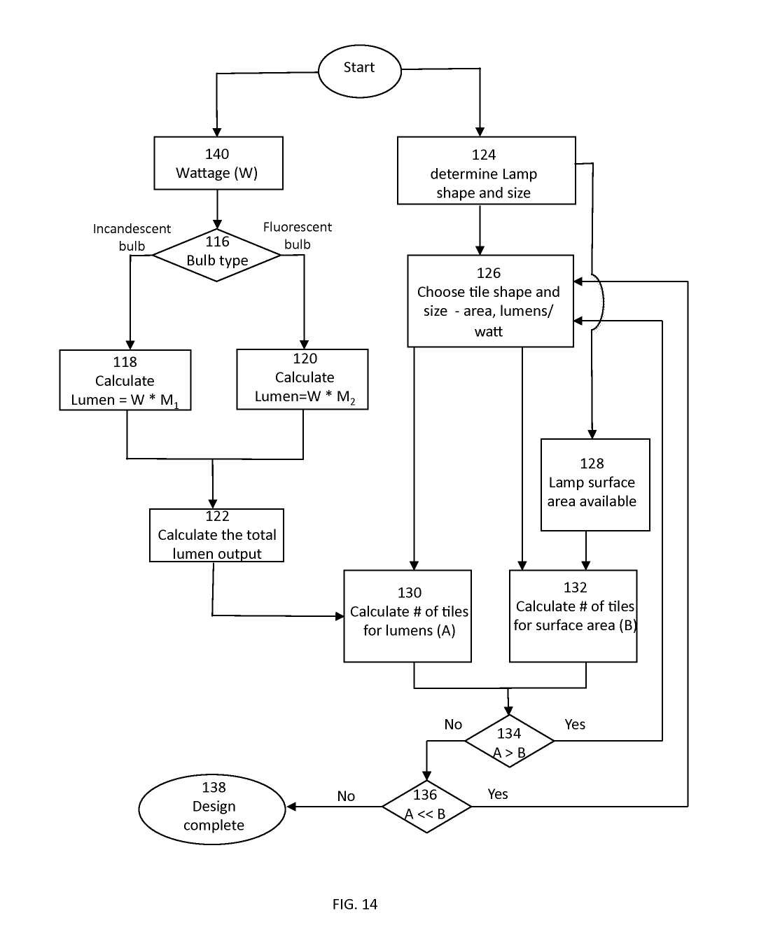

FIG. 14 is a simplified flowchart illustrating the process in designing a light fixture 16 using the self contained LED module tiles 18. The design of the light fixture 44, 46 or 48 begins by estimating the light output required from the light fixture and the size of the fixture. In one embodiment, the process is performed by a computer running a software application. In another embodiment, the process is conducted by a combination of the computer and inputs from a designer. At step 140 the computer obtains the information on the wattage of an existing bulb. At step 116, the type of bulb is considered to determine whether the bulb is an incandescent bulb or a fluorescent bulb, and such information is entered into the computer. If the bulb is an incandescent bulb, at step 118, the computer calculates the lumen output by multiplying the wattage of the bulb by a first multiplier M₁, such as a numerical value 17. If the bulb is a fluorescent bulb, at step 120 the computer calculates the lumen output by multiplying the wattage of the bulb by a second multiplier M₂, such as numerical value 65. The first and second multipliers are intended as exemplary numbers, and do not limit other numerical values as calculated depending a user's preferences. At step 122, the computer then calculates the value of total lumen output, which provides an estimation of the actual lumen output from the selected bulb in step 116.

Alternatively, if the lumen output target for the lamp fixture 44, 46 or 48 is known, one can bypass the above sequence, and instead begins with step 124. At step 124, the lamp shape and size of one of the selected lamp fixtures 44, 46 and 48 are entered into the computer. At step 126, the tile shape and size are chosen and entered into the computer. For example, if the selected lamp fixture has a circular shape, a hexagonal self-contained LED module tile may be an appropriate tile to use. At step 128, the computer calculates the available lamp surface area of the light fixture where the self-contained LED module tiles are placed. Step 132 then gets the number (B) of tiles that can fit in this available area from the size of the tiles chosen in step 126.

Steps 122 and 126 converge at step 130, where the computer computes the number of tiles, denoted by the symbol A, required to produce the total lumen output. At step 132, which converges from steps 126, 128, the computer computes the number of tiles, denoted by the symbol B that can fit in the available surface area of the lamp. At step 134, the computer compares the two tile numbers A and B. If the A number of tiles is greater than the B number of tiles, which indicates that the size of tiles chosen at step 126 is insufficient to produce the lumen output required from the lamp, the computer returns the process to step 126 and chooses a different tile, where a tile has a smaller area or a tile with a larger lumen output and the same area. Steps 126, 130, 132 are then repeated. If the A number of tiles is not greater than the B number of tiles, the process continues to step 136, where the computer determines whether the A number of tiles is significantly less than the B number of tiles (if A<<B). This comparison indicates that the lamp surface area to be covered is significantly larger than what the tiles are actually covering. If the A number of tiles is significantly less than the B number of tiles, the computer returns the process back to step 126 and selects a different tile with a larger area, but with the same lumen output or same area with lesser lumen output, and repeats steps 126, 130, 128, 132, 134, 136. If the A number of tiles is not significantly less than the B number of tiles, at step 138, the design is complete and the design criteria have met.

Additionally, these LED tiles may also contain intelligence such that the behavior of a number of these LED tiles may be coordinated. For example, a lamp could be changed from performing whole room illumination to a reading lamp by switching on/off a section of tiles in the lamp.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” or “communicatively coupled” as used herein are defined as connected, although not necessarily directly, and not necessarily mechanically.

The invention can be implemented in numerous ways, including as a process, an apparatus, a system. In this specification, these implementations, or any other form that the invention may take, may be referred to as techniques. In general, the order of the connections of disclosed apparatus may be altered within the scope of the invention.

The present invention has been described in particular detail with respect to one possible embodiment. Those of skilled in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

An ordinary artisan should require no additional explanation in developing the methods and systems described herein but may nevertheless find some possibly helpful guidance in the preparation of these methods and systems by examining standard reference works in the relevant art.

These and other changes can be made to the invention in light of the above detailed description. In general, in the following claims, the terms used should not be construed to limit the invention to the specific embodiments disclosed in the specification and the claims, but should be construed to include all methods and systems that operate under the claims set forth herein below. Accordingly, the invention is not limited by the disclosure, but instead its scope is to be determined entirely by the following claims.

We claim:

1. A light apparatus, comprising:
a surface area for illumination;
a plate assembly spaced apart from the surface area having a plurality of sockets; and
a plurality of individually replaceable LED tiles, each LED tile coupled to a corresponding socket, the plurality of individually replaceable LED tiles extending from the socket to form a lighting surface for projecting light.

2. The lighting apparatus of claim 1, wherein the surface comprises an open face.

3. The lighting apparatus of claim 1, wherein the surface comprises a plane.

4. The lighting apparatus of claim 1, wherein the surface comprises a cylindrical-shaped surface.

5. The lighting apparatus of claim 1, wherein the surface comprises a trapezoidal-shaped surface.

6. The lighting apparatus of claim 1, wherein each of the plurality of individually replaceable LED tiles comprises a geometric-shaped LED tile.

7. The lighting apparatus of claim 1, wherein each of the plurality of individually replaceable LED tiles comprises a trapezoidal-shaped LED tile.

8. The lighting apparatus of claim 1, wherein each of the plurality of individually replaceable LED tiles comprises a rectangular-shaped LED tile.

9. The lighting apparatus of claim 1, wherein each of the plurality of individually replaceable LED tiles comprises a triangular-shaped LED tile.

10. The lighting apparatus of claim 1, wherein each of the plurality of individually replaceable LED tiles comprises a circular-shaped LED tile.

11. The lighting apparatus of claim 1, wherein each LED tile comprises an AC power supply and LED driver, coupled to a respective LED tile, for driving a DC signal to the respective LED.

12. The lighting apparatus of claim 1, wherein each LED tile comprises a DC power supply and LED driver, coupled to a respective LED tile, for driving a DC signal to the respective LED tile.

13. The lighting apparatus of claim 1, wherein each LED tile comprises vent holes for cooling the LED tile.

14. The lighting apparatus of claim 1, wherein each LED tile comprises a plurality of LEDs.

15. The lighting apparatus of claim 1, wherein each LED tile comprises at least an LED, a heat sink, a light collator and a connector.

16. The lighting apparatus of claim 1, wherein the plate assembly comprises of sockets for receiving a plurality of LED tiles, a connector to couple to a supply source and wires to couple the sockets to the connector.

17. The lighting apparatus of claim 17, wherein the supply source is an AC.

18. The lighting apparatus of claim 17, wherein the supply source is a DC.

19. The lighting apparatus of claim 17, wherein the plate assembly further comprises at least a power supply.

20. The lighting apparatus of claim 17, wherein the plate assembly further comprises at least an LED driver.
